(19) United States
(12) Patent Application Publication
(10) Pub. No.: US 2011/0257324 A1
(43) Pub. Date: Oct. 20, 2011

(54) Polymer Blends Comprising Alkoxysilane-Terminated Polymers

(75) Inventors: Wolfgang Ziche, Burghausen (DE); Andreas Bauer, Kirchdorf (DE); Volker Stanjek, Ampfing (DE)

(73) Assignee: Wacker Chemie AG, Munich (DE)

(21) Appl. No.: 13/139,180

(22) PCT Filed: Dec. 10, 2009
(86) PCT No.: PCT/EP2009/066798

§ 371 Date: Jun. 10, 2011

(30) Foreign Application Priority Data
Dec. 11, 2008 (DE) 10 2008 054 541.4

(51) Int. Cl. C08L 83/16; C08K 3/26; C08K 3/36; C08L 75/08; C08L 75/12

(52) U.S. Cl. 524/500

(57) ABSTRACT

The invention relates to a blend (M), comprising A) 100 parts of an alkoxysilylmethyl-terminated polymer (A) with at least one end group of the general formula (1) -L-(CH₂)—SiR²₃₋ₓ(OR¹) x (1), with L being a double-bond linking group selected from —O—, —S—, —(R³)N—, —O—CO—N(R³)—, —N(R³)—CO—O—, —N(R³)—CO—NH—, —NH—CO—N(R³)—, —N(R³)—CO—N(R³), R¹ and R² are independently hydrocarbon radicals with 1-6 carbon atoms or ω-lkyl-alkyl radicals with a total of 2-20 carbon atoms, R³ is hydrogen, an optionally halogen-substituted cyclic, linear or branched C₁ to C₁₈-alkyl or alkenyl radical or a C₆- to C₁₈-aryl radical, and x is 2 or 3, B) 0.01 to 10 parts of a curing catalyst (K) that accelerates the curing of the blend (M) in the presence of air humidity, C) 0 to 1000 parts of one or more fillers (F), D) 0 to 50 parts of one or more monomeric silanes (S) as water traps and silane cross-linkers, E) 0 to 200 parts of one or more plasticizers (W) and F) 0 to 50 parts of one or more adhesion promoters (H) and F) optionally other additives, wherein the blend (M) comprises less than 2 parts of one or more compounds with a primary amine function and less than 0.2 parts of one or more catalyst that contains tin.

### CROSS REFERENCE TO RELATED APPLICATIONS

This application is the national phase filing of international patent application No. PCT/EP2009/066798, filed 10 Dec. 2009, and claims priority of German patent application number 10 2008 054 541.4, filed 11 Dec. 2008, the entireties of which applications are incorporated herein by reference.

### FIELD OF THE INVENTION

The invention relates to blends (M) which comprise methyldialkoxysilylmethyl- or trialkoxysilylmethyl-terminated polymers, to shaped articles produced from these blends, and to the use of the blends (M) for adhesive bonding of workpieces.

### BACKGROUND OF THE INVENTION

Polymer systems which possess reactive alkoxysilyl groups are well established. In the presence of atmospheric moisture, these alkoxysilane-terminated polymers are capable, even at room temperature, of condensing with one another, with elimination of the alkoxy groups. Depending on the amount of alkoxysilane groups and on their construction, the products are principally long-chain polymers (thermoplastics), relatively wide-meshed three-dimensional networks (elastomers) or else highly crosslinked systems (thermosets).

In line with the countless possibilities for the design of silane-terminated polymer systems of this kind, not only the properties of the non-crosslinked polymers or of the polymer-containing mixtures (viscosity, melting point, solubilities, etc.) but also the properties of the fully crosslinked compositions (hardness, elasticity, tensile strength, elongation at break, heat resistance, etc.) can be tailored on a virtually custom basis. Correspondingly diverse, therefore, are the possibilities for the use of such silane-terminated polymer systems as well. Thus, for example, they can be used for producing elastomers, sealants, adhesives, elastic adhesive systems, rigid and flexible foams, any of a very wide variety of coating systems, or for impression compounds. These products can be applied in any form, as for example by spreading, spraying, pouring, pressing, knifing, etc. depending on the composition of the formulations.

As well as the curing of the compositions and the mechanical properties of the vulcanizate, a requirement, particularly in the case of applications in the adhesives and sealants segment, is for high adhesion to a host of different substrates, and good elastic properties. Formulations of silane-crosslinking polymers generally exhibit very good properties in these respects.

The adhesion profile is often enhanced or optimized by adding organofunctional silanes as adhesion promoters. Silanes having primary amino groups such as 3-aminopropyltrimethoxysilane, in particular, lead here to a distinct improvement in the adhesion properties, and hence this type of silane is present virtually in all adhesives and sealants based on silane-terminated polymers. The use of such silanes is prior art and is described in various monographs or publications (e.g., Silanes and other coupling agents, Vol 1-3, editor K. L. Mittal VSP, Utrecht 1992; Silane Coupling Agents, E. P. Plueddemann, 2nd edition, Plenum Press, New York 1991). In addition, there are also special, newly developed adhesion promoter silanes, as described in EP 997469 A or EP 1216263 A, although a combination of silanes, as shown in EP 1179571 A, is often conducive.

As well as good adhesion, adhesives, and especially sealants, are also required to have very good elasticity. A part is played here not only by the elongation, but also by the relaxation after elongation or compression. This is typically measured as compression set, creep behavior, or resilience behavior. For example, ISO 11600 requires a resilience of more than 60% or even 70% for elastic sealants.

The elastic behavior is often determined by the formulation, but also by the nature of the silane-crosslinking based polymers. Organic silane-crosslinking polymers, especially those having difunctional end groups on the polymer, often exhibit inadequate resiliences. Here, it is the formulation that is critical for the properties. For example, U.S. Pat. No. 6,576,733 describes a way of improving the resilience by means of a special catalyst system which, however, contains tin. It is known, further, that the use of branched polymers produces an increase in the network density and hence an improvement in the elasticity. A disadvantage here, however, is the reduction in the chain lengths between two network nodes that accompanies branching, and that typically leads to a marked deterioration in mechanical properties, particularly the elongation at break, but also the tensile strength.

DE 102006022834 describes the use of aminoalkylalkoxysilanes in combination with epoxy-functional silanes for improving the resilience. Disadvantages in that case are the increase in the modulus and the deterioration in the adhesion.

One type of particular interest among the silane-terminated polymers is notable for the separation of the reactive alkoxysilyl groups only by one methylene spacer from an adjacent heteroatom. These so-called α-alkoxysilylmethyl end groups possess particularly high reactivity with respect to atmospheric moisture. Corresponding polymers are described in WO 03/014226, for example. For sufficiently rapid curing, these polymers need only very small amounts of toxicologically critical tin catalysts, or none at all, and are able on requirement to achieve substantially higher curing rates. Accordingly, the use of α-alkoxysilyl-terminated prepolymers of this kind is usually particularly desirable.

Nevertheless, elastomers which can be produced from this highly reactive α-silane-crosslinking polymer type have the disadvantage, in comparison to elastomers formed from conventional silane-crosslinking polymers which crosslink via γ-alkoxysilylpropyl end groups, of a much lower resilience, which for many applications is insufficient.

### SUMMARY OF THE INVENTION

It is an object of the invention, therefore, to provide blends based on α-silane-crosslinking polymers that in the cured state, following elongation, exhibit a high resilience.

### DETAILED DESCRIPTION OF THE INVENTION

The invention provides blends (M) comprising
A) 100 parts of an alkoxysilylmethyl-terminated polymer (A) having at least one end group of the general formula (1)

-L-(CH₂)—SiR²₃₋ₓ(OR¹)ₓ (1),
where
L is a divalent linking group selected from —O—, —S—, —(R³)N—, —O—CO—N(R³)—, —N(R³)—CO—O—, —N(R³)—CO—NH—, —NH—CO—N(R³)—, —N(R³)—CO—N(R³)
R¹ and R² independently of one another are hydrocarbon radicals having 1-6 carbon atoms or ω-oxaalkyl-alkyl radicals having in total 2-20 carbon atoms,
R³ is hydrogen, an optionally halogen-substituted cyclic, linear or branched C₁ to C₁₈ alkyl or alkenyl radical or a C₆ to C₁₈ alkyl radical, and
x is 2 or 3,
B) 0.01 to 10 parts of a curing catalyst (K) which accelerates the curing of the blend (M) in the presence of atmospheric moisture,
C) 0 to 1000 parts of one or more fillers (F),
D) 0 to 50 parts of one or more monomeric silanes (S) as water scavengers and silane crosslinkers,
E) 0 to 200 parts of one or more plasticizers (W) and
F) 0 to 50 parts of one or more adhesion promoters (H), and
F) optionally further additions and additives,
   characterized
   in that the blend (M) contains less than 2 parts of one or more compounds with primary amine function and less than 0.2 parts of one or more tin-containing catalysts.

In the formula (1), L is preferably —O—CO—N(R²)—N(R²)—CO—NH—, —NH—CO—N(R²)— and —N(R²)—CO—N(R²)—, more preferably —O—CO—N(R²), more particularly —O—CO—NH.
x is preferably 3.

Examples of R¹, R² and R³ are alkyl radicals, such as the methyl, ethyl, n-propyl, isopropyl, n-butyl, isobutyl, tert-butyl, n-pentyl, isopentyl, neopentyl, tert-pentyl radical, hexyl radicals, such as the n-hexyl radical, heptyl radicals, such as the n-heptyl radical, octyl radicals, such as the n-octyl radical and isooctyl radicals, such as the 2,2,4-trimethylpentyl radical, nonyl radicals, such as the n-nonyl radical, decyl radicals, such as the n-decyl radical, dodecyl radicals, such as the n-dodecyl radical; alkenyl radicals, such as the vinyl and the allyl radical; cycloalkyl radicals, such as cyclopentyl, cyclohexyl, cycloheptyl radicals and methylcyclohexyl radicals; aryl radicals, such as the phenyl and the naphthyl radical; alkaryl radicals, such as o-, m-, p-tolyl radicals, xylyl radicals and ethylphenyl radicals; aralkyl radicals, such as the benzyl radical, the α- and the β-phenylethyl radical.

The radicals R¹ and R² are preferably hydrocarbon radicals having 1 to 6 carbon atoms, more particularly alkyl radicals having 1 to 4 carbon atoms. R² is more preferably a methyl radical, R¹ is more preferably methyl or ethyl radicals.

The radical R³ is preferably hydrogen or a hydrocarbon radical having 1 to 6 carbon atoms, more preferably hydrogen, an alkyl radical having 1 to 4 carbon atoms, more particularly hydrogen.

The blend (M) preferably comprises less than 1 part, more preferably less than 0.5 parts—more particularly less than 0.2 parts—of one or more compounds with primary amine function. With particular preference the blend (M) is free from any compounds with primary amine function.

The blend (M) preferably comprises less than 0.1 parts, more preferably less than 0.05 parts—more particularly less than 0.02 parts—of one or more tin catalysts; more preferably, the blend (M) is free from any tin-containing catalysts.

The invention is based on the surprising finding that compounds with primary amine functions significantly impair the resilience in blends (M) based on polymers (A) with α-silane functions corresponding to the formula (1). This finding is particularly surprising in that a comparable impairment of the resilience is apparent only in blends (M) based on the α-silane-terminated polymers (A), but not in the long-established and well-investigated systems based on conventional γ-alkoxysilylpropyl-terminated prepolymers. In other words, what is present here is quite evidently an entirely new and hitherto unknown mechanism of action, which is why primary amines exhibit such an effect in the system according to the invention.

At the same time, the inventive use of only small amounts of primary amines, or the entire renunciation of the use of this product group, is also not an obvious solution, since compounds of these kinds—more particularly aminosilanes such as aminopropyltrimethoxysilane, N-(2-aminoethyl)aminopropyltrimethoxysilane or N-(2-aminoethyl)aminopropylmethyldimethoxysilane—are typically employed in significantly higher amounts in any adhesive and sealant based on silane-terminated polymers, as adhesion promoters, water scavengers and/or (co)catalysts.

The blends (M) of the invention are preferably characterized in that shaped articles (F) which consist of the cured blend (M) exhibit, after 24-hour elongation by 30%, a resilience DIN 53504 of more than 60%, preferably of more than 65% and more preferably of more than 70%.

The main chains of the alkoxysilane-terminated polymers (A) which can be used may be branched or unbranched. The average chain lengths may be adapted arbitrarily in line with the particular desired properties both of the non-crosslinked mixture and of the cured composition. They may be constructed from different building blocks. Typically these are polysiloxanes, polysiloxaneurea/urethane copolymers, polyurethanes, polyureas, polyethers, polyesters, polyacrylates and polymethacrylates, polycarbonates, polystyrenes, polyamides, polyvinyl esters or polyolefins such as, for example, polyethylene, polybutadiene, ethylene-olefin copolymers or styrene-butadiene copolymers. It will be appreciated that any desired mixtures or combinations of polymers with different main chains may also be used.

For the preparation of polymers (A) with silane-terminations of the general formula (1), a multiplicity of possibilities are known. In particular:
Copolymerizations with participation of unsaturated monomers which possess groups of the general formula (1). Examples of such monomers might be (meth)acryloyloxymethyltrimethoxysilane, (meth)acryloyloxymethylmethyldimethoxysilane and the corresponding ethoxysilyl compounds.
Graft attachment of unsaturated monomers which possess groups of the general formula (1) to thermoplastics such as polyethylene. Examples of such monomers might be, again, (meth)acryloyloxymethyltrimethoxysilane, (meth)acryloyloxymethylmethyldimethoxysilane and the corresponding ethoxysilyl compounds.
Reaction of prepolymers (A1), which possess suitable functional groups with one or more organosilanes (A2) of the general formula (2)

B—(CH₂)—SiR²₃₋ₓ(OR¹)ₓ (2)

in which x, Fe and R² have the definitions stated above, and
B is a functional group which is reactive toward the functional groups of the prepolymers (A1).

Where the prepolymer (A1) is itself composed of two or more building blocks (A11, A12 . . . ), then it is not absolutely necessary for the prepolymer (A1) to first be prepared from these building blocks (A11, A12 . . . ) and then reacted with the silane (A2) to give the finished polymer (A). Accordingly, here as well, a reversal of the reaction steps is possible, in which one or more building blocks (A11, A12 . . . ) are first reacted with the silane (A2), and the compounds obtained in this step are only then reacted with the remaining building blocks (A11, A12 . . . ) to give the finished polymer (A).

Examples of prepolymers (A1) consisting of building blocks (A11 and A12) are OH- , NH- , or NCO-terminated polyurethanes and polyureas which are preparable from polyisocyanates (building block A11) and from polyols (building block A12).

In one preferred mode of preparation of the prepolymers (A), a silane (A2) is used which is selected from silanes of the general formula (3)

OCN—(CH₂)—SiR²₃₋ₓ(OR¹)ₓ (3)

where all of the variables possess the definitions indicated above.

In the preparation of the prepolymers (A), the concentrations of all of the isocyanate groups and all of the isocyanate-reactive groups that are involved in all of the reaction steps, and also the reaction conditions, are preferably selected such that all of the isocyanate groups are consumed by reaction in the course of the polymer synthesis. The finished polymer (A) is therefore preferably isocyanate-free.

Examples of prepolymers (A1) are polyesters, polycarbonates, polyestercarbonates (e.g. those available commercially under the name “Desmophen 1700” and “Desmophen C-200” from Bayer AG, Germany), polybutenylenes and polybutadienylenes (e.g. those available commercially under the name “Poly bd® R-45 HTLO” from Sartomer Co., Inc., USA or “Kraton™ Liquid L-2203” from Kraton Polymers US L.L.C.).

Preferred examples of prepolymers (A1) for preparing prepolymers (A) are polyesters, polyethers, and polyurethanes. Particularly preferred examples of prepolymers (A1) are divalent polyethers of the general formula (4)

HO—(R⁴O)ₘ-H (4),

where
R⁴ may be identical or different and denotes optionally substituted hydrocarbon radicals, preferably methylene, ethylene, and 1,2-propylene radicals and
m is an integer from 1 to 600, preferably 50 to 400.

Examples of prepolymers (A1) of the general formula (4) are available commercially under the name “Acclaim 12200”, “Acclaim 18000” (both Bayer AG, Germany), “Alcupol 12041LM” from Repsol, Spain and “Poly L 220-10” from Arch Chemicals, USA.

In the polymer blends (M) of the invention, the fraction of alkoxysilane-terminated polymers (A) is preferably 10-70% by weight, more preferably 15-50% by weight, more particularly 20-40% by weight.

In addition to the prepolymers (A), the inventive blends (M) preferably comprise one or more secondary or tertiary amines (B) as curing catalyst (K). Examples of aminoalkoxysilanes with secondary or tertiary amino function such as 3-(N-cyclohexylamino)propyltrimethoxysilane, 3-(N-cyclohexylamino)propyltriethoxysilane, 3-(N-phenylamino)propyltrimethoxysilane, 3-(N-phenylamino)propyltriethoxysilane, triethylamine, tributylamine, 1,4-diazabicyclo[2.2.2]octane, N,N-bis(N,N-dimethyl-2-aminoethyl)methylamine, N,N-dimethylcyclohexylamine, N,N-dimethylphenylamine, N-ethylmorpholinine.

With particular preference, the inventive blends (M), as well as the prepolymers (A), comprise one or more secondary or tertiary aminoalkylalkoxysilanes (KS) as curing catalyst (K).

Preferred aminoalkylalkoxysilanes (KS) are those of the general formula (5)

R⁵R⁶N—(CR⁷₂)—Si (R²)3-x(OR¹)x (5),

in which
R⁵,R⁷ are hydrogen or an alkyl, cycloalkyl, alkenyl or aryl radical having 1-10 carbon atoms, it being possible for said radical optionally to be substituted by halogen atoms and/or organic functions,
R⁶ is an alkyl, cycloalkyl, alkenyl or aryl radical having 1-10 carbon atoms, it being possible for said radical optionally to be substituted by halogen atoms and/or organic functions, or is a divalent alkyl, cycloalkyl, alkenyl or aryl radical having 1-10 carbon atoms, it being possible for said radical optionally to be substituted by halogen atoms,
   and all other variables have the definitions indicated above,
the aminoalkylalkoxysilane (KS) possessing no primary amino function.
R5 is preferably a hydrogen atom or an alkyl, cycloalkyl, or aryl group having 1-10 carbon atoms, more preferably a hydrogen atom or an alkyl group having 1-8 carbon atoms. R⁶ is preferably an alkyl, cycloalkyl or aryl radical having 1-10 carbon atoms, with phenyl radicals, cyclohexyl radicals or alkyl radicals having 1-8 carbon atoms being particularly preferred.
R⁷ is preferably hydrogen.

Particularly preferred are aminoalkylalkoxysilanes (KS) of the general formula (5) in which
R³ is methyl,
R⁴, R⁶ is hydrogen,
R⁵ is cyclohexyl or phenyl.

In the polymer blends (M) of the invention, the fraction of aminoalkylalkoxysilane (KS) is preferably 0.1-10% by weight, more preferably 0.1-5% by weight, more particularly 0.2-3% by weight, based on the total weight of the blend.

The polymer blends (M) of the invention may comprise further condensation catalysts (K), examples being titanate esters, such as tetrabutyl titanate, tetrapropyl titanate, tetraisopropyl titanate, tetraacetylacetonate titanate or else acidic catalysts, such as phosphoric acid and phosphoric esters, toluene sulphonic acids, mineral acids. The various catalysts may be used both in pure form and as mixtures.

These further condensation catalysts are added preferably in concentrations of 0.01-10% by weight, more preferably 0.1-2% by weight, based on the total weight of the blend, to the polymer blends (M).

In addition, the blends (M) of the invention may also comprise tin compounds, such as dibutyltin dilaurate, dibutyltin maleate, dibutyltin diacetate, dibutyltin dioctanoate, dibutyltin acetylacetonate, dibutyltin oxide or corresponding compounds of dioctyltin, within the concentration limits indicated above, as curing catalysts (K). Preferably, however, the blends (M) of the invention are tin-free.

Furthermore, the blends (M) of the invention may also comprise primary amines, more particularly primary aminosilanes such as 3-aminopropyltrimethoxysilane or 3-aminopropyltriethoxysilane, within the concentration limits indicated above, as curing catalysts (K). Preferably, however, the blends (M) of the invention are free from primary amines.

The polymer blends of the invention further comprise, preferably, fillers (F), examples being calcium carbonates in the form of natural ground chalks, ground and coated chalks, precipitated chalks, precipitated and coated chalks, clay minerals, bentonites, kaolins, talc, titanium dioxides, aluminum oxides, aluminum trihydrate, magnesium oxide, magnesium hydroxide, carbon black, precipitated or fumed, hydrophilic or hydrophobic silicas.

Preference is given to using calcium carbonates and precipitated or fumed, hydrophilic or hydrophobic silicas, more preferably fumed, hydrophilic or hydrophobic silicas, more particularly fumed hydrophilic silicas.

The fillers (F) are added preferably in concentrations of 10-70% by weight, more preferably 30-60% by weight, based on the total weight of the blend, to the polymer blends (M).

In addition to the silanes optionally used as catalyst (K) (including the silanes (KS) conforming to the formula (5)), the polymer blends (M) of the invention may also comprise further silanes (S) with or without additional organic function. These silanes serve preferably as water scavengers and/or silane crosslinkers, examples being alkylsilanes such as methyltrimethoxysilane, vinylsilanes such as vinyltrimethoxy-, vinyltriethoxy-, vinylmethyldimethoxysilane or organofunctional silanes such as O-methylcarbamatomethylmethyldimethoxysilane, O-methylcarbamatomethyltrimethoxysilane, O-ethylcarbamatomethylmethyldiethoxysilane, O-ethylcarbamatomethyltriethoxysilane, glycidyloxypropyltrimethoxysilane, etc. All silanes specified as catalysts (K) may also serve as water scavengers and/or crosslinkers.

The water scavenger and/or silane crosslinker silanes (S) are added preferably in concentrations of 0.1-10% by weight, more preferably 0.5-2% by weight, based on the total weight of the blend, to the polymer blends (M).

All silanes (S) and also the silanes used as catalysts (K) (including the silanes (KS) conforming to the formula (5)) may at the same time also serve as adhesion promoters (H). In addition, the blends (M) of the invention may of course also comprise further adhesion promoters (H).

The polymer blends of the invention may comprise plasticizers (W), examples being phthalate esters, such as dioctyl phthalate, diisooctyl phthalate, diundecyl phthalate, adipic esters, such as dioctyl adipate, benzoic esters, glycol esters, phosphoric esters, sulfonic esters, polyesters, polyethers, polystyrenes, polybutadienes, polyisobutenes, paraffinic hydrocarbons, higher, branched hydrocarbons, etc.

The plasticizers (W) are added, preferably in concentrations of up to 40% by weight, based on the total weight of the blend, to the polymer blends (M).

The polymer blends (M) of the invention may further comprise thixotropic agents, examples being hydrophilic fumed silicas, coated fumed silicas, precipitated silicas, polyamide waxes, hydrogenated castor oils, stearate salts or precipitated chalks. The fillers identified above may also be utilized for adjusting the flow properties.

The thixotropic agents are added preferably in concentrations of 1-5% by weight, based on the total weight of the blend, to the polymer blends (M).

The polymer blends of the invention may further comprise light stabilizers, such as so-called HALS stabilizers, fungicides, flame retardants, pigments, etc. as are known for use in conventional alkoxy-crosslinking one-component compositions.

For generating the particular desired profiles of properties both of the non-crosslinked polymer blends and of the cured compositions, above additions are preferably employed.

In the preparation of the polymer blends (M) of the invention it is preferred first to prepare a mixture of polymer (A) and filler and then to add aminoalkylalkoxysilane (BS).

Shaped articles (F), such as bonded joints, for example, which can be produced by curing the blends (M) of the invention are likewise provided by the invention. The shaped articles (F) preferably, after 24-hour elongation by 30%, have a resilience DIN 53504 of more than 60%, preferably of more than 65%, and more preferably of more than 70%.

For the polymer blends of the invention there exist countless different applications in the area of adhesives, sealants and joint-sealants, surface coatings, and also in the production of impression compounds and shaped articles.

The polymer blends of the invention here are suitable for countless different substrates such as, for example, mineral substrates, metals, plastics, glass, ceramic, painted surfaces, etc.

All above symbols in the above formulae have their definitions in each case independently of one another. In all formulae the silicon atom is tetravalent.

In the examples below, unless indicated otherwise, all amounts and percentages are by weight.

### EXAMPLES

### Examples 1

Formulations with a Silane-Terminated Polyether having Methylene-Trimethoxysilyl End Groups (Alpha-Trimethoxy)

35 g of a silane-terminated polyether available according to EP 1,534,940 B from Acclaim Polyol 12200S (Bayer Material Science AG) and isocyanatomethyltrimethoxysilane are mixed in a Speedmixer from Hauschild (D-59065 Hamm) at about 25° C. with 25 g of PPG 2000 (from Dow Chemical) and 3 g of methylcarbamatotrimethoxysilane, available under the name GENIOSIL® XL63 (Wacker Chemie AG), at 200 rpm for 2 minutes. Thereafter 1.50 g of a hydrophilic fumed silica HDK® N20 (170-230 m³/g) (Wacker Chemie AG) are incorporated with stirring until it is homogeneously distributed. Subsequently 60.4 g of Carbital 1105 chalk (from Imerys) are introduced and the filler is digested with stirring for one minute at 600 rpm. Following incorporation of the chalk, 0.1 g of cyclohexylaminomethyltriethoxysilane (GENIOSIL® XL926—Wacker Chemie AG) are dispersed at 200 rpm for one minute. For 2 minutes at 600 rpm and 1 minute at 200 rpm in a partial vacuum (approximately 100 mbar) there is homogenization and bubble-free stirring.

The formulation is dispensed into 310 ml PE cartridges and stored at 25° C. for one day.

Comparative example 1b is produced in the same way, but using aminopropyltrimethoxysilane (GENIOSIL® GF96—Wacker Chemie AG) instead of the cyclohexylaminomethyltriethoxysilane.

| | | Comparative |
|---|---|---|
| | Example 1a | example 1b |
| Silane-terminated polyether | 35 | 35 |
| PPG 2000 | 25 | 25 |
| GENIOSIL XL 63 | 3 | 3 |
| HDK N 20 | 1.5 | |
| HDK H 15 | | 1.5 |
| Chalk-Carbital 110 | 60.4 | 60.4 |
| GENIOSIL XL 926 | 0.1 | |
| GENIOSIL GF 96 | | 0.1 |
| (aminopropyltrimethoxysilane) | | |
| Skin-forming time | 17 min | 5 min |
| Vulcanizate as per DIN 53504 and DIN 53505 | | |
| Modulus S2 in N/mm² | 1.3 | 1.04 |
| Shore A | 43 | 33 |
| Elongation at break S2 in % | 106 | 164 |
| Tensile strength S2 in N/mm² | 1.3 | 1.7 |
| Resilience (after 2 wks RT) | 83% | 0% |
| Resilience (after 4 wks RT) | 92% | 8% |

### Examples 2

Formulations with a Silane-Terminated Polyether having Methylene-Triethoxysilyl End Groups (Alpha-Triethoxy)

35 g of a silane-terminated polyether available according to EP 1,534,940 B from Acclaim Polyol 18200S (Bayer Material Science AG) and isocyanatomethyltriethoxysilane are mixed in a Speedmixer from Hauschild (D-59065 Hamm) at about 25° C. with 25 g of PPG 2000 (from Dow Chemical) and 3 g of methylcarbamatotrimethoxysilane, available under the name GENIOSIL® XL63 (Wacker Chemie AG), at 200 rpm for 2 minutes. Thereafter 1.50 g of a hydrophilic fumed silica HDK® N20 (170-230 m³/g) (Wacker Chemie AG) are incorporated with stirring until it is homogeneously distributed. Subsequently 60.4 g of Carbital 1105 chalk (from Imerys) are introduced and the filler is digested with stirring for one minute at 600 rpm. Following incorporation of the chalk, 0.1 g of cyclohexylaminomethyltriethoxysilane (GENIOSIL® XL926—Wacker Chemie AG) are dispersed at 200 rpm for one minute. For 2 minutes at 600 rpm and 1 minute at 200 rpm in a partial vacuum (approximately 100 mbar) there is homogenization and bubble-free stirring.

The formulation is dispensed into 310 ml PE cartridges and stored at 25° C. for one day.

Example 2b is produced in the same way, but using the hydrophilic fumed silica HDK® H15 (170-230 m²/g, Wacker Chemie AG) instead of the HDK® N20.

| | Example 2a | Example 2b |
|---|---|---|
| Silane-terminated polyether | 35 | 35 |
| PPG 2000 | 25 | 25 |
| GENIOSIL XL 63 | 3 | 3 |
| HDK N 20 | 1.5 | |
| HDK H 15 | | 1.5 |
| Chalk-Carbital 110 | 60.4 | 60.4 |
| GENIOSIL XL 926 | 0.1 | 0.1 |
| Vulcanizate as per DIN 53504 and DIN 53505 | | |
| Modulus S2 in N/mm² | 1.28 | 1.21 |
| Shore A | 39 | 40 |
| Elongation at break S2 in % | 246 | 285 |
| Tensile strength S2 in N/mm² | 1.9 | 1.9 |
| Resilience (after 2 wks RT) | 71% | 71% |
| Resilience (after 4 wks RT) | 83% | 100% |

### Examples 3

Formulations with a Silane-Terminated Polyether having Methylene-Dimethoxysilyl End Groups (Alpha-Dimethoxy)

35 g of a silane-terminated polyether available according to EP 1,534,940 B from Acclaim Polyol 122005 (Bayer Material Science AG) and isocyanatomethyldimethoxysilane are mixed in a Speedmixer from Hauschild (D-59065 Hamm) at about 25° C. with 25 g of PPG 2000 (from Dow Chemical) and 3 g of methylcarbamatotrimethoxysilane, available under the name GENIOSIL® XL63 (Wacker Chemie AG), at 200 rpm for 2 minutes. Thereafter 1.50 g of a hydrophilic fumed silica HDK® N20 (170-230 m²/g) (Wacker Chemie AG) are incorporated with stirring until it is homogeneously distributed. Subsequently 60.4 g of Carbital 1105 chalk (from Imerys) are introduced and the filler is digested with stirring for one minute at 600 rpm. Following incorporation of the chalk, 0.1 g of cyclohexylaminomethyltriethoxysilane (GENIOSIL® XL926—Wacker Chemie AG) are dispersed at 200 rpm for one minute. For 2 minutes at 600 rpm and 1 minute at 200 rpm in a partial vacuum (approximately 100 mbar) there is homogenization and bubble-free stirring.

The formulation is dispensed into 310 ml PE cartridges and stored at 25° C. for one day.

Comparative example 3b is produced in the same way, but using aminopropyltrimethoxysilane (GENIOSIL® GF96—Wacker Chemie AG) instead of the cyclohexylaminomethyltriethoxysilane.

| | | Comparative |
|---|---|---|
| | Example 3a | example 3b |
| Silane-terminated polyether | 35 | 35 |
| PPG 2000 | 25 | 25 |
| GENIOSIL XL 63 | 3 | 3 |
| HDK N 20 | 1.5 | 1.5 |
| Chalk-Carbital 110 | 60.4 | 60.4 |
| GENIOSIL XL 926 | 0.1 | |
| GENIOSIL GF 96 | | 0.1 |
| (aminopropyltrimethoxysilane) | | |
| Vulcanizate as per DIN 53504 and DIN 53505 | | |
| Modulus S2 in N/mm² | 1.2 | 1.3 |
| Shore A | 44 | 45 |
| Elongation at break S2 in % | 292 | 247 |
| Tensile strength S2 in N/mm² | 1.9 | 2.1 |
| Resilience (after 2 wks RT) | 33% | 0% |
| Resilience (after 4 wks RT) | 67% | 17% |

### Determination of the Mechanical Properties

The samples were coated out onto milled-out Teflon plates with a depth of 2 mm and were cured at 23° C. and 50% relative humidity for 2 weeks.

The mechanical properties were determined in accordance with DIN 53504 (tensile testing) and DIN 53505 (Shore A hardness). The resilience was measured after storage of the S2 test specimens (DIN 53504) at 23° C. and 50% relative humidity for 2 and 4 weeks beforehand. The test specimens were elongated by 30% for 24 h. The resilience was determined after 1 h relaxation at 23° C. and 50% relative humidity.

1. A blend (M) comprising
A) 100 parts of an alkoxysilylmethyl-terminated polymer (A) having at least one end group of the general formula (1)
-L-(CH₂)—SiR²₃₋ₓ(OR¹)ₓ (1),
where
L is a divalent linking group selected from —O—, —S—, —(R³)N—, —O—CO—N(R³)—, —N(R³)—CO—O—, —N(R³)—CO—NH—, —NH—CO—N(R³)—, —N(R³)—CO—N(R³)
R¹ and R² independently of one another are hydrocarbon radicals having 1-6 carbon atoms or ω-oxaalkyl-alkyl radicals having in total 2-20 carbon atoms,
R³ is hydrogen, an optionally halogen-substituted cyclic, linear or branched C₁ to C₁₈ alkyl or alkenyl radical or a C₆ to C₁₈ aryl radical, and
x is 2 or 3,
B) 0.01 to 10 parts of a curing catalyst (K) which accelerates the curing of the blend (M) in the presence of atmospheric moisture,
C) 0 to 1000 parts of one or more fillers (F),
D) 0 to 50 parts of one or more monomeric silanes (S) as water scavengers and silane crosslinkers,
E) 0 to 200 parts of one or more plasticizers (W) and
F) 0 to 50 parts of one or more adhesion promoters (H), and
F) optionally further additions and additives,
wherein the blend (M) contains less than 2 parts of one or more compounds with primary amine function and less than 0.2 parts of one or more tin-containing catalysts.

2. The blend (M) of claim 1, wherein
L is an —O—CO—N(H) group.

3. The blend (M) of claim 1, wherein one or more secondary or tertiary amines (B) are included as curing catalyst.

4. The blend (M) of claim 3, wherein the one or more secondary or tertiary amines (B) comprise one or more secondary or tertiary aminoalkylalkoxysilanes (BS).

5. The blend (M) of claim 4, wherein the aminoalkylalkoxysilanes (BS) are of the general formula (4)
(R⁴R⁵N—(CR⁶₂)—Si(R³)₃₋ₓ(OR¹)ₓ (4)
in which
R³ is an alkyl, alkenyl or aryl radical having 1-10 carbon atoms,
R⁴, R⁶ are hydrogen or an alkyl, cycloalkyl, alkenyl or aryl radical having 1-10 carbon atoms, said radical optionally being substituted by halogen atoms and/or organic functions,
R⁵ is an alkyl, cycloalkyl, alkenyl or aryl radical having 1-10 carbon atoms, said radical optionally being substituted by halogen atoms and/or organic functions,
or is a divalent alkyl, cycloalkyl, alkenyl or aryl radical having 1-10 carbon atoms, said radical optionally being substituted by halogen atoms, and
x is a number from 1 to 3,
the aminoalkylalkoxysilane (BS) possessing no primary amino function.

6. The blend (M) of claim 5, wherein in the aminoalkylalkoxysilane (BS) of the general formula (4)
R³ is methyl,
R⁴, R⁶ are hydrogen,
R⁵ is cyclohexyl or phenyl, and
x is 2 or 3.

7. A shaped article comprising a blend according to claim 1.

8. The shaped article of claim 7, wherein after 24-hour elongation by 30% the shaped article exhibits a resilience to DIN 53504 of more than 70%.

9. The blend of claim 3, wherein L is an —O—CO—N(H) group.

10. The blend of claim 4, wherein L is an —O—CO—N(H) group.

11. The blend of claim 5, wherein L is an —O—CO—N(H) group.

12. The blend of claim 6, wherein L is an —O—CO—N(H) group.

13. The shaped article of claim 7, wherein L is an —O—CO—N(H) group.

14. The shaped article of claim 8, wherein L is an —O—CO—N(H) group.
